(19) United States
(12) Patent Application Publication
(10) Pub. No.: US 2026/0194372 A1
(43) Pub. Date: Jul. 9, 2026

(54) Optical Flow Processing for Chirp-Pulse Coherent OTDR

(71) Applicant: NEC Laboratories America, Inc., Princeton, NJ (US)

(72) Inventor: Jian Fang, Princeton, NJ (US)

(73) Assignee: NEC Laboratories America, Inc., Princeton, NJ (US)

(21) Appl. No.: 19/443,008

(22) Filed: Jan. 7, 2026

Related U.S. Application Data
(60) Provisional application No. 63/742,987, filed on Jan. 8, 2025.
(60) Provisional application No. 63/745,459, filed on Jan. 15, 2025.

(51) Int. Cl. G01D 5/353; G01B 11/16; G01H 9/00; G01K 11/32

(52) U.S. Cl. CPC G01D 5/35361; G01B 11/16; G01H 9/004; G01K 11/32

(57) ABSTRACT

A system and method for distributed temperature and strain sensing using Chirp-Pulse Coherent Optical Time-Domain Reflectometry (CP-COTDR) utilizes optical flow processing. The method involves constructing a two-dimensional (2-D) waterfall data array from collected CP-COTDR frames. Optical flow processing is applied directly to the 2-D data to estimate the local shift of features caused by external perturbations. The optical flow is preferably calculated using a weighted least squares method with an adaptive analysis window based on the local flatness of signal derivatives. This approach provides versatile and high spatial resolution, reduces accumulative errors, and enables efficient data processing compared to conventional cross-correlation techniques.

### CROSS REFERENCE TO RELATED APPLICATIONS

This application claims the benefit of U.S. Provisional Patent Application Ser. No. 63/742,987 filed Jan. 8, 2025, and U.S. Provisional Patent Application Ser. No. 63/745,459 filed Jan. 15, 2025, the entire contents of each of which is incorporated by reference as if set forth at length herein.

### FIELD OF THE INVENTION

This application relates generally to optical fiber sensing technologies. More particularly, it pertains to distributed fiber optic sensing (DFOS) including distributed temperature sensing (DTS) and strain sensing using chirp-pulse coherent optical time-domain reflectometry (CP-COTDR) utilizing optical flow processing techniques.

### BACKGROUND OF THE INVENTION

Rayleigh-based Coherent Optical Time-Domain Reflectometry (COTDR) is a widely adopted technology based on Rayleigh backscattering in optical fiber. COTDR enables continuous, real-time measurement of external perturbations along a fiber. Conventional COTDR typically sends single-frequency optical pulses into a sensing fiber as probe light to detect external acoustic or vibration signals, but it is typically not suitable for temperature or strain sensing.

To address this limitation, Chirp-Pulse Coherent OTDR (CP-COTDR) utilizes chirp-modulated optical pulses as the probe light to enable distributed temperature and strain sensing. CP-COTDR features extremely high sensitivity to temperature and strain compared to Raman-based and Brillouin-based approaches, while offering rapid updating speeds and robustness to Rayleigh fading.

The measurement mechanism of CP-COTDR generally relies on a “local” shift estimation between a data frame and a reference frame. In conventional processing, CP-COTDR data frames are divided into segments of equal length. Cross-correlation is then performed between aligned data segments of two consecutive frames to determine the local shift via peak searching on the correlation profile.

However, conventional CP-COTDR processing faces several limitations. First, the segment length must contain a sufficient number of data points to perform accurate cross-correlation, which limits spatial resolution. For example, a 10-meter segment might yield only one local shift value. Second, temperature or strain changes within a single segment may be nonuniform; conventional methods treat all data points in a segment, leading to degraded sensitivity if only a portion of the segment changes. Furthermore, CP-COTDR generates massive amounts of data, creating challenges for storage and processing.

### SUMMARY OF THE INVENTION

An advance in the art is made according to aspects of the present invention directed to an optical flow processing technique for CP-COTDR.

In sharp contrast to the prior art that utilized one-dimensional cross-correlation processing, systems and methods according to aspects of the present invention process a two-dimensional (2-D) image constructed from raw waterfall CP-COTDR data.

Operationally, systems and methods according to aspects of the present invention determine the optical flow of each pixel in the 2-D data which advantageously allows for the reconstruction of local shifts through ensemble averaging and cumulative summation.

Consequently, systems and methods according to aspects of the present disclosure significantly improve spatial resolution as compared to cross-correlation techniques, reduce accumulative errors, and compress data size(s). Furthermore, systems and methods according to aspects of the present disclosure allow for versatile spatial resolution; and given any desired resolution and time interval, optical flows can immediately yield local shifts.

As shall be shown and described, particularly inventive aspects of the present invention include: construction of 2-D image from raw waterfall data; a method to estimate of the partial derivatives along x- and t-directions; a method to determine the analysis window size based on the flatness of the derivative matrix; a method to select the local partial derivative matrix from surrounding pixels within the analysis window; a method to calculate the optical flow of each pixel via the weighted least squares; and a method to calculate the local shift from optical flows with a given spatial resolution and time period

### BRIEF DESCRIPTION OF THE DRAWING

FIG. 1 is a schematic flow diagram showing illustrative steps of the inventive processes according to aspects of the present invention.

FIG. 2 is a schematic diagram of an illustrative CP-COTDR configuration according to aspects of the present invention.

FIG. 3 is a schematic diagram of an illustrative data structure of CP-COTDR according to aspects of the present invention.

FIG. 4 is a plot showing an illustrative zoomed-in area of CP-COTDR data according to aspects of the present invention.

FIG. 5 is a schematic diagram plot of an illustrative pixel-wise optical flow in 2D COTDR data according to aspects of the present invention.

FIG. 6(A) and FIG. 6(B) are plots showing 2D maps of: FIG. 6(A), x direction; and FIG. 6(B), y direction derivatives of FIG. 4 according to aspects of the present invention.

FIG. 7 is a quiver plot showing illustrative optical flow from data in FIG. 4 in which units are pixels according to aspects of the present invention.

FIG. 8 is a plot showing illustrative local shift of each location along the optical fiber through the ensemble average and cumulative summation according to aspects of the present invention.

FIG. 9 is a schematic diagram showing illustrative features in hierarchical format of systems and methods according to aspects of the present invention.

FIG. 10 is a schematic showing illustrative overall data structure of CP-COTDR according to aspects of the present invention.

FIG. 11 is a schematic diagram showing illustrative overall pixel-wise optical flow in 2D COTDR data according to aspects of the present invention.

FIG. 12(A) is a schematic showing illustrative experimental setup according to aspects of the present invention.

FIG. 12(B) and FIG. 12(C) are plots showing illustrative experimental accumulative optical flow track within 2 m spatial resolution for the experimental setup according to aspects of the present invention.

FIG. 12(D) and FIG. 12(E) are plots showing illustrative experimental water heating and cooling processes for the experimental setup according to aspects of the present invention.

FIG. 13 is a schematic diagram showing an illustrative computer system in which methods of the instant invention may be executed.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGS. comprising the drawing are not drawn to scale.

### CP-COTDR Overall Process

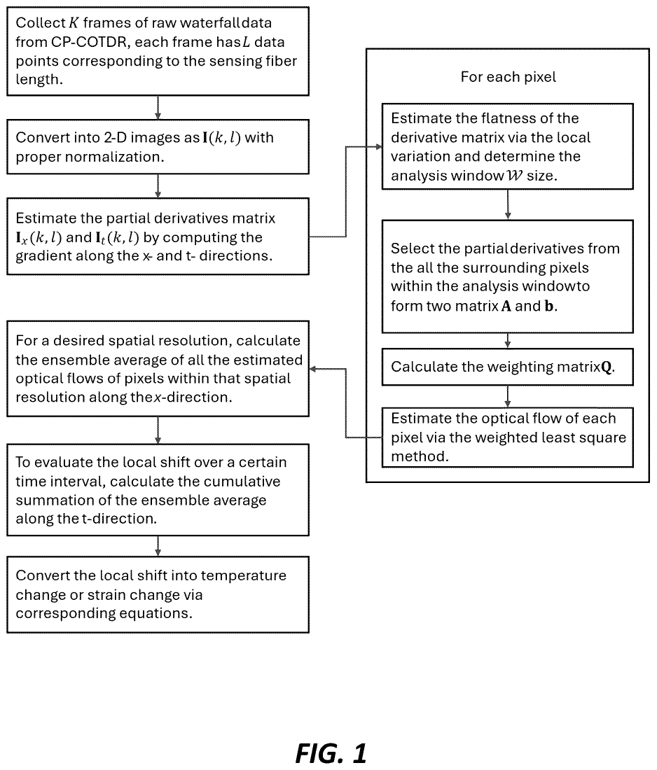

FIG. 1 is a schematic flow diagram showing illustrative steps of the inventive processes according to aspects of the present invention.

### CP-COTDR Data

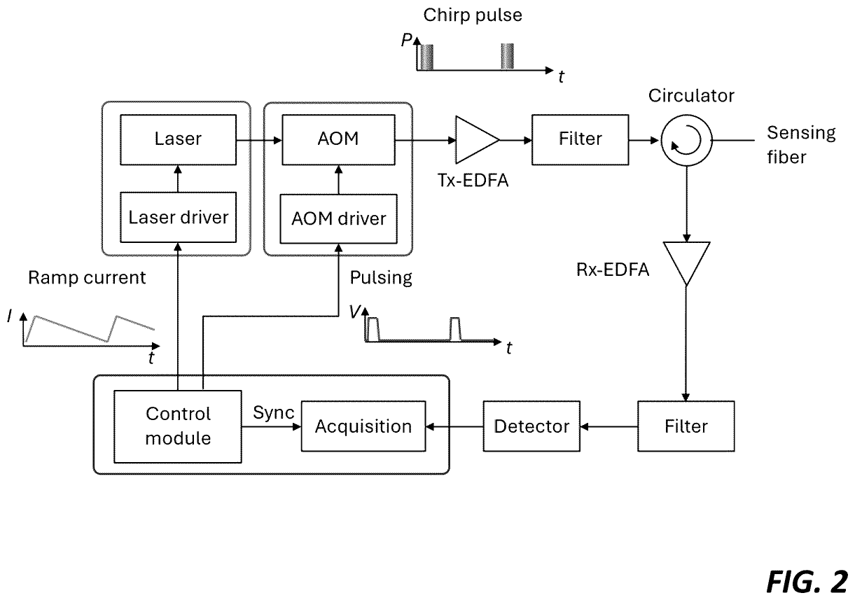

FIG. 2 is a schematic diagram of an illustrative CP-COTDR configuration according to aspects of the present invention.

With reference to that figure, it may be observed that a laser diode, such as a distributed feedback (DFB) laser, is used as the light source. A chirp of laser light is generated by the control module by modulating the current as a Ramp shape through the laser driver. The control module also generates pulsing signal to an acoustic-optic modulator (AOM) which is synchronized to the Ramp signal for chirp generation.

By properly adjusting the delay between the Ramp current signal and the pulsing signal, the chirp pulse can be generated. The generated chirp pulses are then amplified by a Tx-amplifier such as Erbium-doped fiber amplifier (EDFA) to a desired power level. An optional optical filter may be employed to reduce amplified spontaneous emission (ASE) noise from the Tx-EDFA. The chirp pulses are then sent into the sensing fiber through an optical circulator.

Backscattering light from the sensing fiber is amplified by another amplifier (Rx-Amplifier) to increase its power. The output of the Rx-Amplifier may be filtered through a bandpass filter (Rx-filter) to reduce the noise. The signal can be directly detected by the detector, such as a photodiode. The detected data are collected by an acquisition device/module, which is synchronized and triggered by the control unit. The control module and acquisition module can be integrated into an FPGA board.

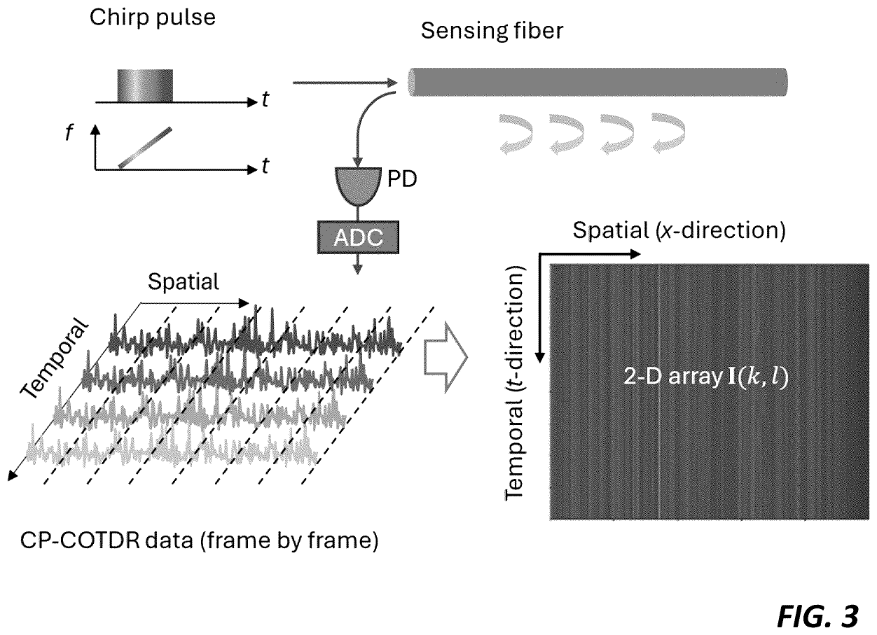

FIG. 3 is a schematic diagram of an illustrative data structure of CP-COTDR according to aspects of the present invention.

With reference to that figure, for each chirp pulse injected into the sensing fiber, the Rayleigh scattering detected by the photodiode will have “in-pulse self-interference” which appears as a speckled 1-D signal. Here we call the 1-D signal from each chirp-pulse as “frame”. The length of a frame corresponds to the time interval between two chirp pulses, and the bandwidth of a frame corresponds to the auto-correlation bandwidth of the chirp pulse. By stacking each frame together, the CP-COTDR data are structured a 2-D array I(k, l), k=1, 2, . . . , K, l=1, 2, . . . . L, in which k and are the location and frame indices, respectively. K and L are the total number of temporal frames and spatial samples, respectively.

As shown in FIG. 3, the 2-D array I(k, l) is also referred to the waterfall of the raw CP-COTDR data for its refreshed with the updated time frame. Since the k index represents the location while the l index corresponds to the time, we also refer the axis of k and l indices as the “x-direction” and the “t-direction”, respectively.

It is noted that when the length of sensing fiber and the ADC sampling rate is fixed, the total number of spatial samples L is also fixed. However, new frames will keep coming continuously so that the total number of frames K increases with time. In this IR, we simply assume the processing of CP-COTDR is semi-real-time, i.e., the L frames stacks together first to form a 2-D image. The 2-D data then are processed in blocks with optical flow processing. By repeating such process, the CP-COTDR could report the sensing results with neglected latency in realistic applications.

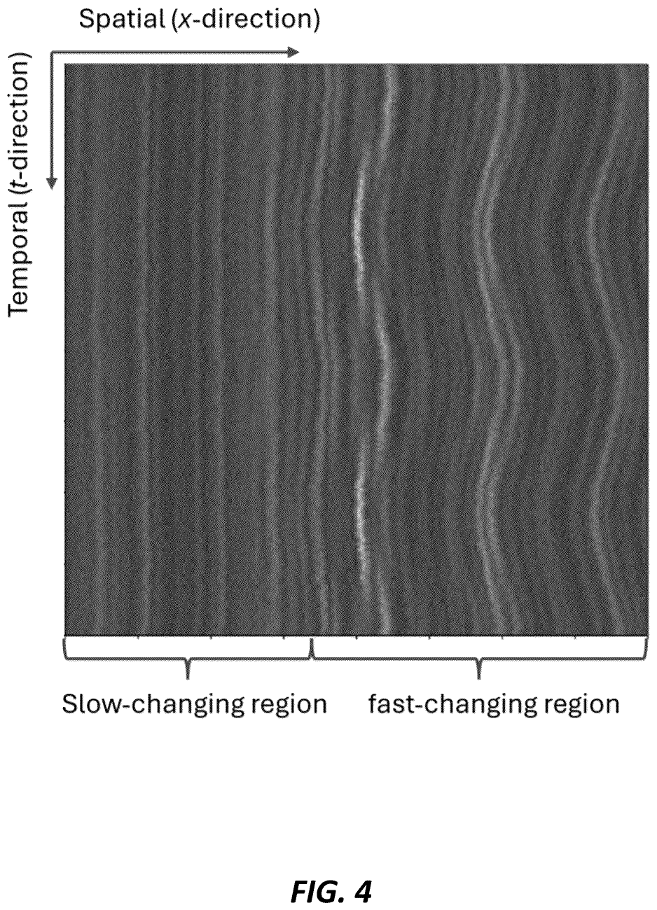

FIG. 4 is a plot showing an illustrative zoomed-in area of CP-COTDR data according to aspects of the present invention.

FIG. 4 illustratively shows a zoom-in area of the CP-COTDR data shown in FIG. 3. The features in some region of the image changes slowly along the t-direction, indicating that the fiber may be under a stable environment (such as slow-varying temperature or static strain). The features in some other region of the image moves quite fast along the t-direction, meaning that the environment condition varies rapidly (such as dynamic strain or vibration).

It is noted that in the waterfall there are many “patterns”. For a given location (and its adjacent points), the shift of the “pattern” along the x-direction corresponds to the relative temperature or strain change. Therefore, the key to CP-COTDR data processing is to accurately estimate the pattern shift of all the locations.

### Optical Flow Processing of CP-COTDR Data

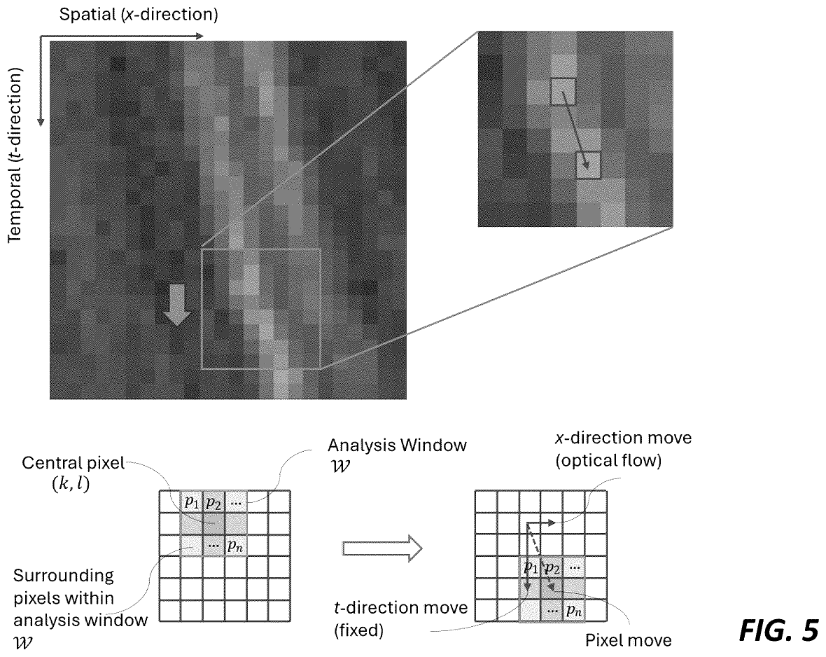

FIG. 5 is a schematic diagram plot of an illustrative pixel-wise optical flow in 2D COTDR data according to aspects of the present invention.

One particularly inventive aspect of the present disclosure is a new processing technique for CP-COTDR which is based on optical flow. Optical flow is a concept in computer vision that refers to the apparent motion of objects, surfaces, and edges in a visual scene caused by the relative motion between the observers and the scenes. It represents the distribution of velocities of brightness patterns in an image sequence over time. In CP-COTDR, the optical flow is used for estimating the x-direction move of “pattern” in the raw data waterfall I(k, l), as shown in FIG. 5.

As may be observed, FIG. 5 illustrates the concept of the pixel-wise optical flow in the 2-D COTDR data. A zoom-in area of FIG. 4 is shown in the figure to demonstrate the principle of the 1-D optical flow.

For a given pixel p_{i,j} of the 2-D data, an analysis window of W is used, which includes surrounding pixels around p_{i,j}. The analysis window can be a rectangular window, i.e., a n_{wt}×n_{wx} matrix where n_{wt} and n_{wx} are the number of columns and rows of W, respectively. The analysis window can also be a window of another shape. As noted above, the t-direction move of the analysis window represents the time interval between two “images”. Therefore, we slide the analysis window W around each pixel along the t-direction with a fixed step size in unit of pixels.

The optical flow method assumes that for the displacement of the image features between two consecutive images is small and approximately constant within a neighborhood. The estimation of optical flow is implemented by solving the optical flow constrain equation that:

$${u}_{x} \cdot {I}_{x} + {I}_{t} = 0 ,$$

where uₓ is the horizontal motion vector, Iₓ is the partial spatial gradient along x-direction, and Iₜ is the temporal gradient. The partial derivatives Iₓ and Iₜ can be approximated using the second-order central differences along x- and y-directions which can be expressed as:

$${I}_{x} ( k , l ) = \frac{I ( k , l + {h}_{x} ) - I ( k , l - {h}_{x} )}{2 {h}_{x}} + 𝒪 ( {h}_{x}^{2} )$$

$${I}_{t} ( k , l ) = \frac{I ( k + {h}_{t} , l ) - I ( k - {h}_{t} , l )}{2 {h}_{t}} + 𝒪 ( {h}_{t}^{2} )$$

where k=1, . . . , K, l=1, . . . , L. It is noted that the second-order central difference assumes the image has at least three continuous derivatives, i.e., I∈C³. Therefore, a 2-D Gaussian filter may be applied to the original image to slightly smooth the image.

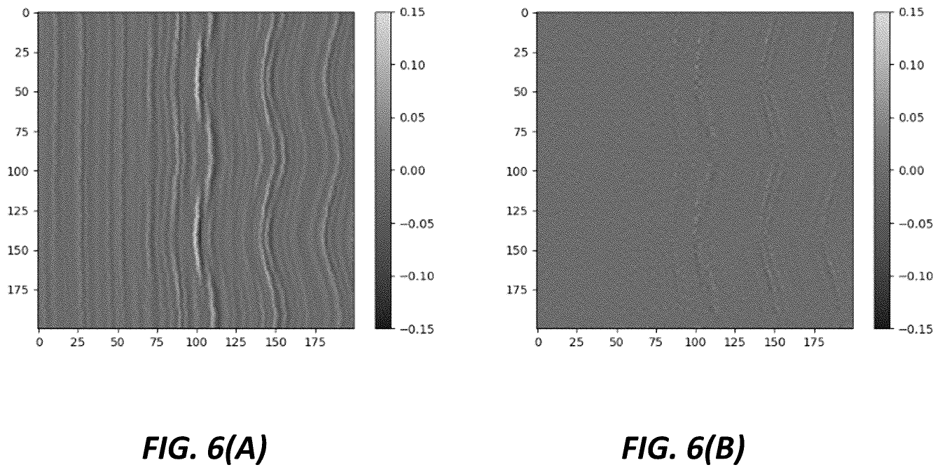

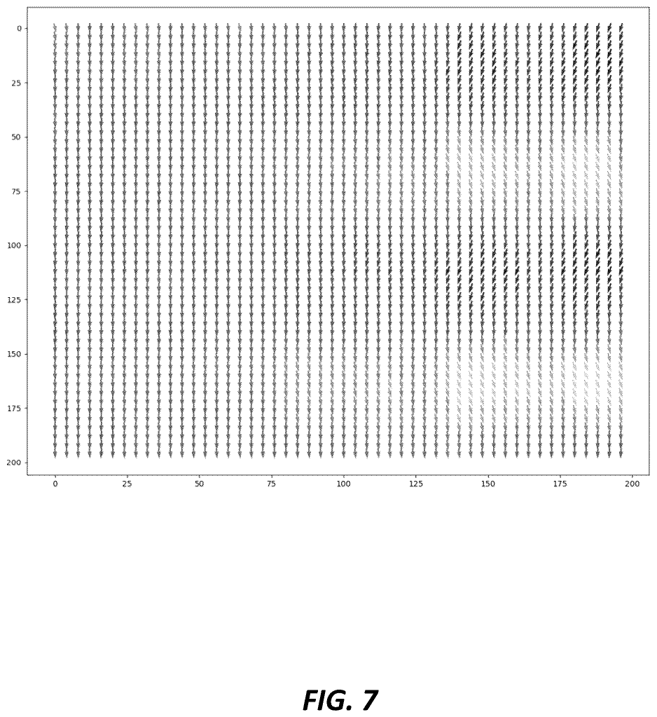

FIG. 6(A) and FIG. 6(B) are plots showing 2D maps of: FIG. 6(A), x direction; and FIG. 6(B), y direction derivatives of FIG. 4 according to aspects of the present invention.

For pixels pᵢ inside analysis window W, the 1-dimensional (along x-direction) optical flow can be expressed as

$${I}_{x} ( {p}_{1} ) {u}_{x} + {I}_{t} ( {p}_{1} ) = 0$$

$${I}_{x} ( {p}_{2} ) {u}_{x} + {I}_{t} ( {p}_{2} ) = 0$$

$$⋮$$

$${I}_{x} ( {p}_{n} ) {u}_{x} + {I}_{t} ( {p}_{n} ) = 0$$

where Iₓ(pᵢ), Iₜ(pᵢ) are the partial derivative of the image I with respect to x, t evaluated at pixel point pᵢ. Therefore, the 1-D optical flow can be simplified as

$$A {u}_{x} = b ,$$

where A=[Iₓ(p₁), Iₓ(p₂), . . . , Iₓ(pₙ)]^{T}, b=[−Iₜ(p₁), −Iₜ(p₂), . . . , −Iₜ(pₙ)]^{T}. Therefore, estimating u can be solved with weighted least square method that.

$${\hat{u}}_{x} = {( {A}^{T} Q A )}^{- 1} {A}^{T} Q b .$$

where Q is the weighting matrix applied to each pixel within the analysis window. The x-direction move ûₓ denotes the local shift of fiber location which corresponds to external temperature or strain variation.

The use of the weighting matrix Q is to avoid the undesired error caused by the “flat” area in Iₓ the partial derivative. When an area of 2-D COTDR pattern is flat, i.e., has low variance with surrounding pixels, the partial derivative will be close to 0, leading to a poor (large) condition number C when inverting the matrix ATA. Therefore, the weighting matrix Q is used to control the “contribution” of the “flat” area and the “feature area”. There are many ways to build the weight matrix. For example, the weighting matrix Q=diag(Qᵢᵢ) can be constructed using A, e.g.:

$${Q}_{i i} = \frac{\vert {A}_{i} \vert}{\sum \vert {A}_{i} \vert} , i = 1 , 2 , … , n$$

The error of least square is given by

$${e}_{x} = ‖ A {\hat{u}}_{x} - b ‖$$

which is used to evaluate the “goodness” of the weighted least squares.

The selection of analysis window W depends on the “flatness” of the x- and t-direction derivatives. It can be quantitively measured by the local variation with the following steps.

First, compute the local variation of flatness metric, such as the standard deviation (SD), for each pixel of Iₜ(k, l) using a fixed window W_{SD}.

Second, map the local variation to the adaptive window size by defining a mapping function between the local SD and t-direction window size, i.e., adaptive

$${n}_{Wt}^{′} .$$

The larger local variation (e.g., SD), the smaller window size, and vice versa. The mapping function of

$${n}_{Wt}^{′}$$

can be linear, logarithmic, or exponential. The x-direction n_{wx} can be fixed.

Third, adjust the window size

$${n}_{Wt}^{′} \times {n}_{Wx}$$

of each pixel according to its local variation and the mapping function.

Fourth, perform slide window analysis when solving the uₓ of each pixel with the dynamically adjusted window sizes and least square algorithm.

FIG. 7 is a quiver plot showing illustrative optical flow from data in FIG. 4 in which units are pixels according to aspects of the present invention.

By applying such process to all the pixels of the CP-COTDR data, the optical flow uₓ represents the direction of move of each pixel. The local shift of a specific location with designated spatial resolution can be implemented through the ensemble averaging over desired pixels along x-direction and cumulative summing along the t-direction.

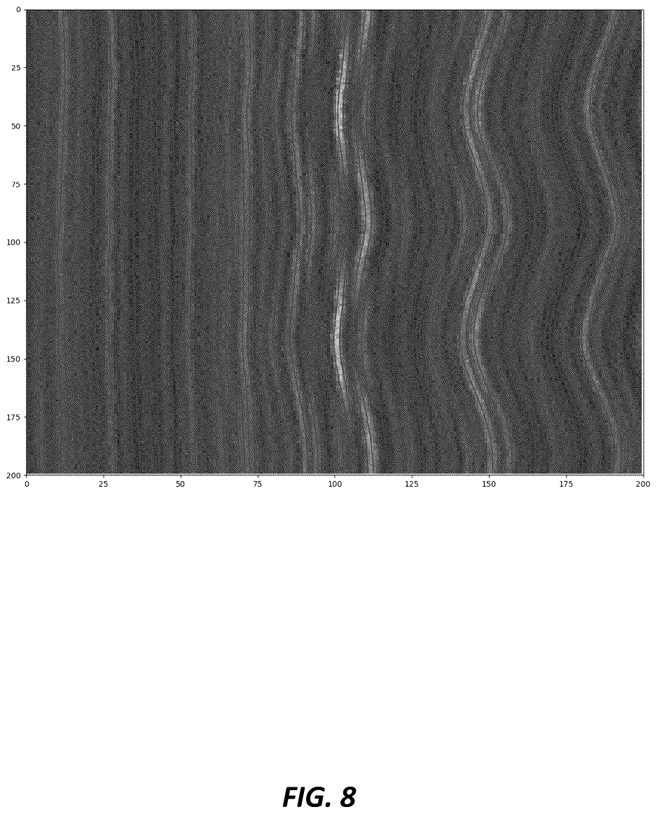

FIG. 8 is a plot showing illustrative local shift of each location along the optical fiber through the ensemble average and cumulative summation according to aspects of the present invention. As noted, FIG. 8 shows the result of the local shift of every location through the ensemble average and the cumulative summation of the optical flows.

The background picture of FIG. 8 is the raw data waterfall. The size of ensemble average is set to 10, meaning that the spatial resolution is 10 spatial samples (or 10 pixels). Note that such a spatial resolution is much smaller than a typical resolution in the conventional cross-correlation method. The plotted lines match the background raw waterfall very well, indicating that the optical flow processing method can give the local shift of each location with high accuracy and high spatial resolution, which proves the effectiveness of our inventive technique.

Revisiting once more, we note that FIG. 1 is a schematic flow diagram showing illustrative steps of the inventive processes according to aspects of the present invention. With reference to that figure the steps of optical flow processing for CP-COTDR can be described as follows:

Collect K frames (each frame has L samples) of CP-COTDR raw waterfall data, convert them into an image I with proper normalization. Notice that this image is I(k, l), where k=1, 2, . . . , K indicates the index along the location direction and l=1, 2, . . . , L means the index along the time direction.

Estimate the partial derivative matrix Iₓ(k, l) and Iₜ(k, l) by computing the gradient along the x- and t-direction from I(k, l).

For each pixel, evaluate the flatness of the derivative matrix via the local variation and determine the corresponding analysis window size W.

For each pixel, select the partial derivatives from the all the surrounding pixels within the analysis window and form two matrix A and b.

Calculate the weighting matrix Q.

Estimate the optical flow of each pixel via the weighted least square method.

Repeat this process to each pixel in the raw waterfall data get the optical flow for all the pixels.

For a desired spatial resolution, calculate the ensemble average of all the estimated optical flows of pixels within that spatial resolution along the x-direction.

To evaluate the local shift over a certain time interval, calculate the cumulative summation of the ensemble average along the t-direction.

Convert the local shift into temperature change or strain change via corresponding equations.

Repeat process (1)-(10) when getting the new CP-COTDR raw waterfall data.

In this way, we can get the dynamic temperature and strain change through the optical flow of each pixel on the CP-COTDR pattern.

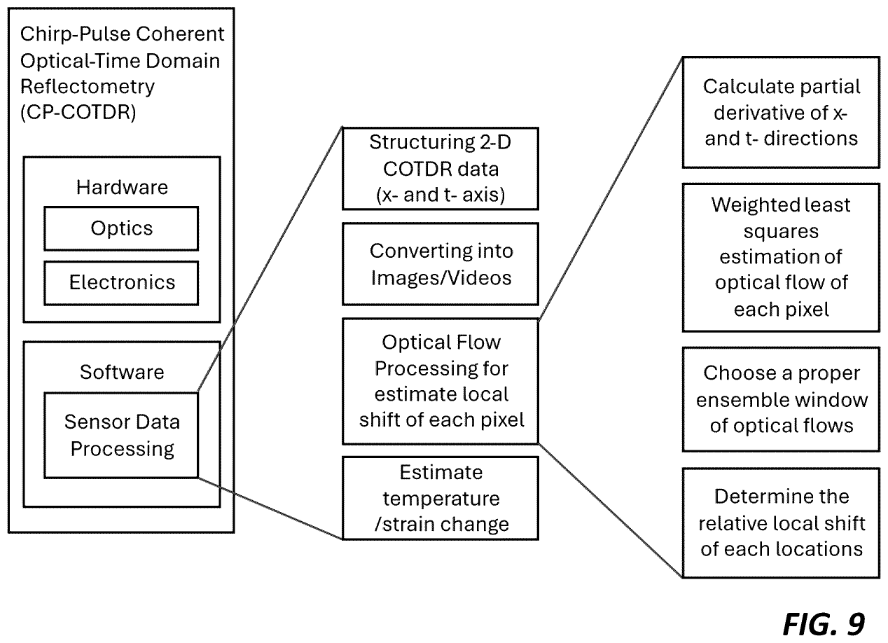

FIG. 9 is a schematic diagram showing illustrative features in hierarchical format of systems and methods according to aspects of the present invention.

Those skilled in the art will understand and appreciate that we have presented an optical flow processing technique for CP-COTDR and that optical flow is a concept in computer vision (CV) that refers to the apparent motion of objects and edges in a visual scene caused by the relative motion between the frames. We have discovered that optical flow can be applied to the 2-D CP-COTDR data to estimate local shift, which is more efficient and accurate than conventional cross-correlation methods known and applied in the art.

### EXPERIMENTAL

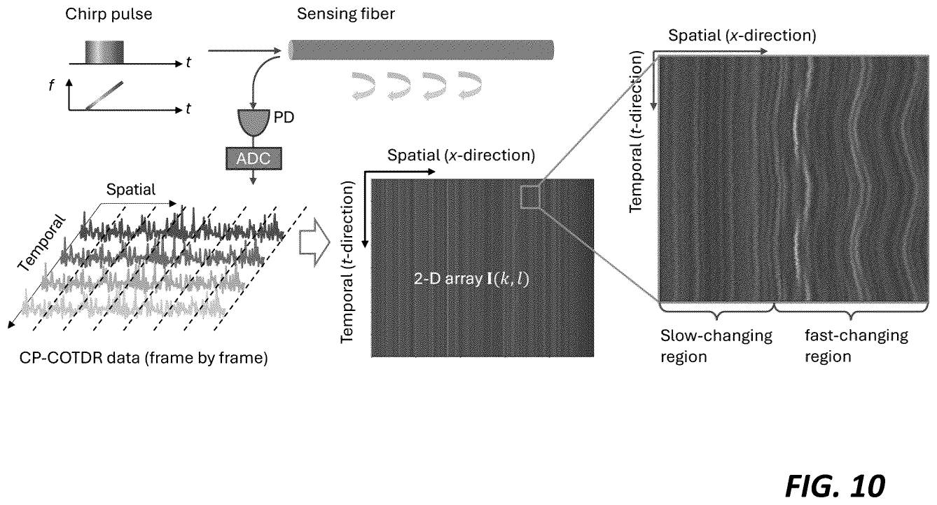

FIG. 10 is a schematic showing illustrative overall data structure of CP-COTDR according to aspects of the present invention.

For each chirp pulse injected into the sensing fiber, the Rayleigh scattering detected by the photodiode will have “in-pulse self-interference” which appears as a speckled 1-D signal. Here we call the 1-D signal from each chirp-pulse as “frame”. The length of a frame corresponds to the time interval between two chirp pulses, and the bandwidth of a frame corresponds to the auto-correlation bandwidth of the chirp pulse. By stacking each frame together, the CP-COTDR data are structured a 2-D array I(k, l), k=1, 2, . . . , K, l=1, 2, . . . . L, in which k and l are the location and frame indices, respectively. K and L are the total number of temporal frames and spatial samples, respectively. As show in FIG. 10, The 2-D array I(k, l) is also referred to the waterfall of the raw CP-COTDR data for its refreshed with the updated time frame. Since the k index represents the location while the l index corresponds to the time, we also refer the axis of k and l indices as the “x-direction” and the “t-direction,” respectively.

It is noted that when the length of sensing fiber and the ADC sampling rate is fixed, the total number of spatial samples L is also fixed. However, new frames will keep arriving continuously so that the total number of frames K increases with time.

We simply assume the processing of CP-COTDR is semi-real-time, i.e., the L frames stacks together first to form a 2-D image. The 2-D data then are processed in blocks with optical flow processing. By repeating such processes, the CP-COTDR could report the sensing results with neglected latency in realistic applications.

FIG. 10 also illustrates a zoom-in area of the CP-COTDR data. The features in some region of the image changes slowly along the t-direction, indicating that the fiber may be under a stable environment (such as slow-varying temperature or static strain). The features in some other region of the image moves quite fast along the t-direction, meaning that the environment condition varies rapidly (such as dynamic strain or vibration).

It is noted that in the waterfall there are many “patterns.” For a given location (and its adjacent points), the shift of the “pattern” along the x-direction corresponds to the relative temperature or strain change. Therefore, the key to CP-COTDR data processing is to accurately estimate the pattern shift of all the locations.

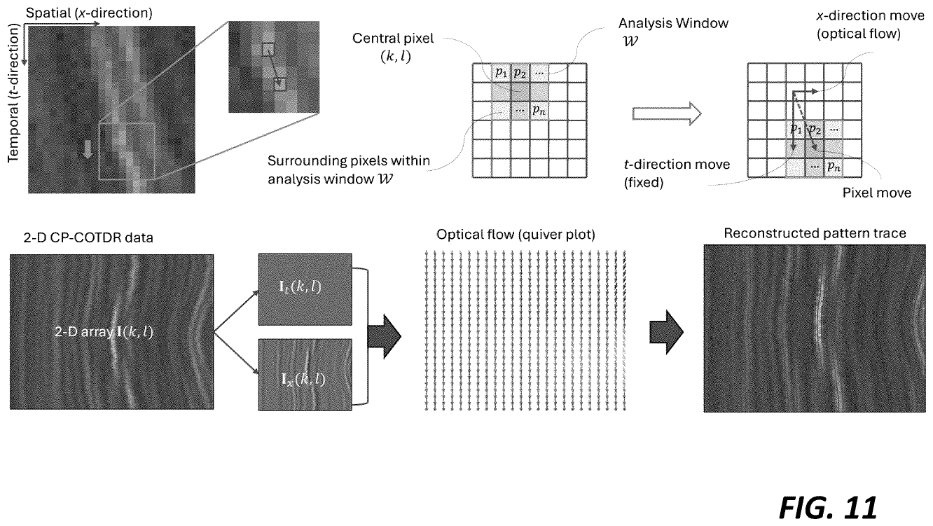

FIG. 11 is a schematic diagram showing illustrative overall pixel-wise optical flow in 2D COTDR data according to aspects of the present invention.

As we have repeatedly noted, optical flow is a concept in computer vision (CV) that represents the distribution of velocities of brightness patterns in an image sequence over time. In CP-COTDR, the optical flow is used for estimating the x-direction move of “pattern” in the raw data waterfall I(k, l). FIG. 11 illustrates the concept of the pixel-wise optical flow in the 2-D COTDR data. For a given pixel p, of the 2D data, an analysis window of W is used, which includes surrounding pixels around p, in a n×n rectangular window. The t-direction move of W represents the time interval between two “images.” Therefore, we slide the analysis window W around each pixel along the t-direction with a fixed step size in unit of pixels.

The optical flow assumes that for the displacement of the image feature between two consecutive images is small and approximately constant within a neighborhood. The estimation of optical flow is implemented by solving the constraint equation that u·Iₓ+Iₜ=0, where u is the x-direction motion vector, I=∂I Ox/and I=∂I ∂t/are the spatial and temporal partial derivatives, respectively, which can be approximated using the second-order central differences as I(k, l) and I(k, l). For any pixel p in analysis window W, the 1-D optical flow along x-direction is given by I(p)·u+I(p)=0, where I, (p) are the partial derivatives evaluated at pixel p. Therefore, the optical flow u can be simplfied as Au=b, where A=[I(p), I(p), . . . , I(p)], b=[−I(p), −I(p), . . . , −I(p)]. Thereby estimating u can be solved with weighted least square (WLS).

To mitigate accumulative error, the analysis window size n×n should be adaptive w.r.t the “flatness” of the partial derivatives which are estimated via the local standard deviation (SD) within a fixed window W. For each pixel, The larger local SD, the smaller window size and vice versa. The local shift of the CP-COTDR of a special location can be reconstructed through the ensemble average of the accumulative optical flow trace within a desired spatial resolution L, as shown in FIG. 11.

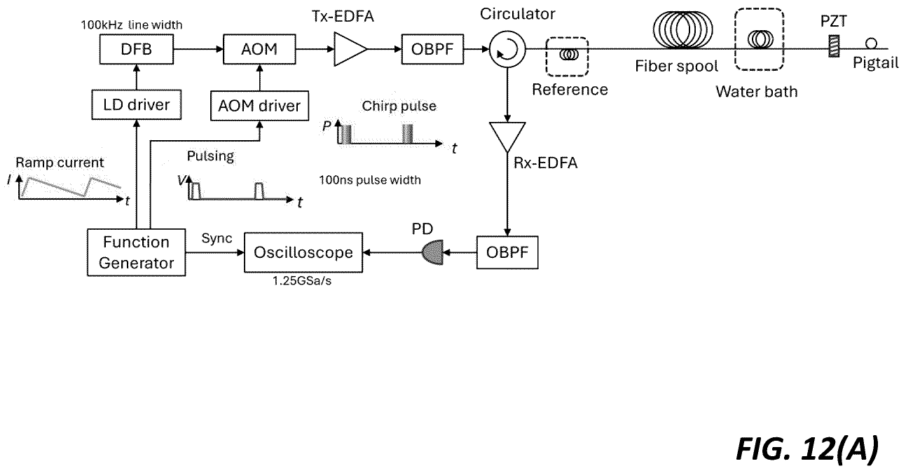

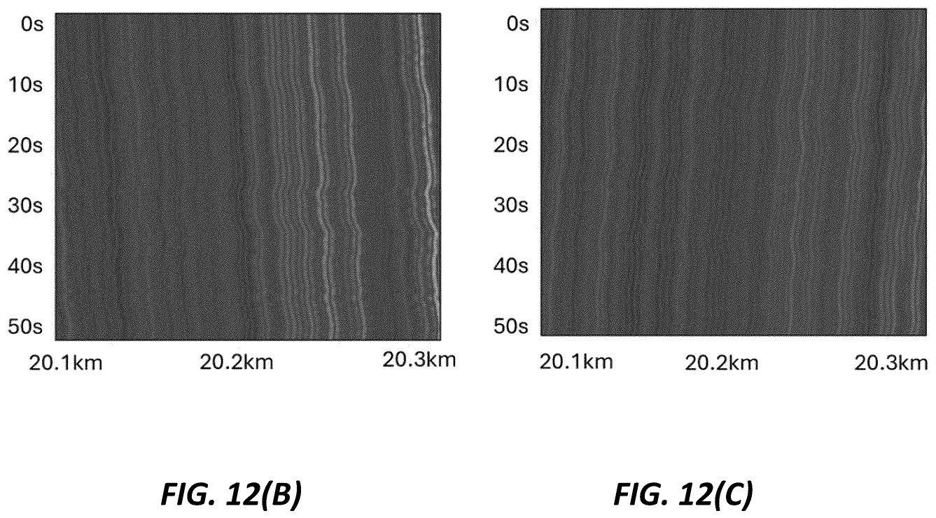

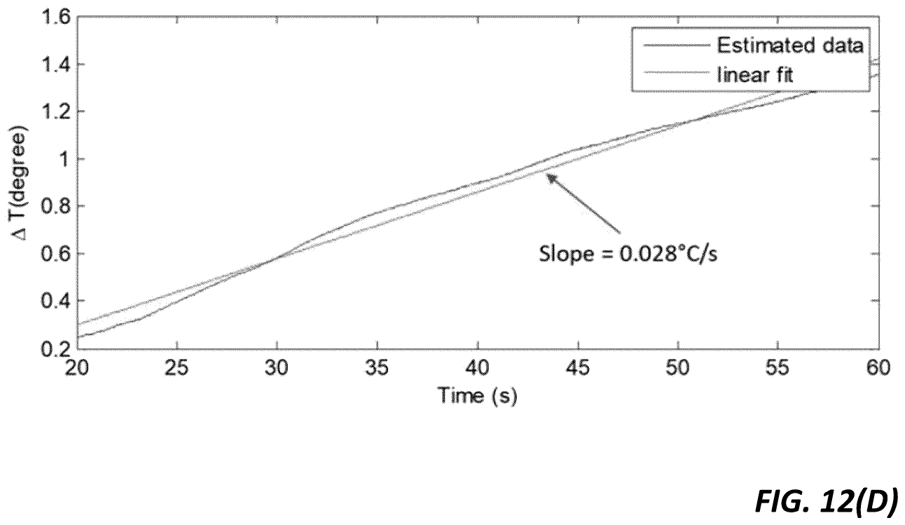

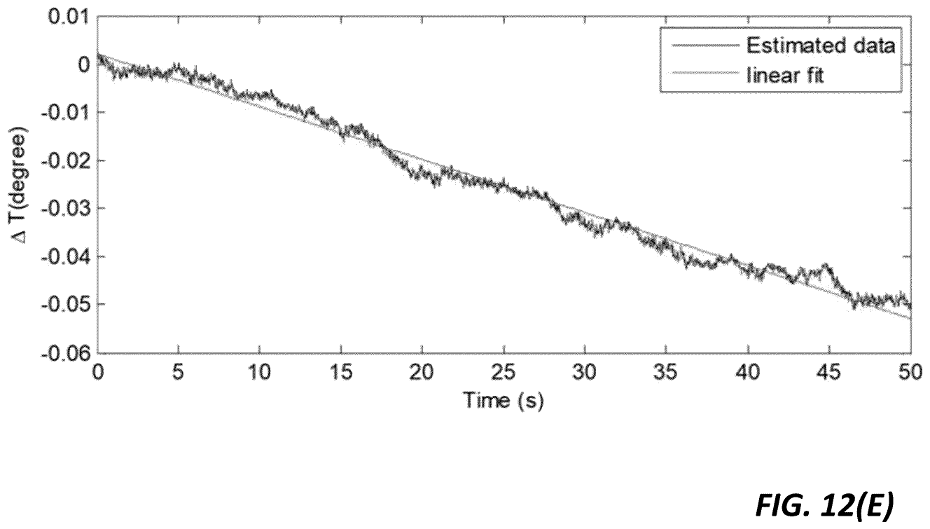

FIG. 12(A) is a schematic showing illustrative experimental setup according to aspects of the present invention. FIG. 12(B) and FIG. 12(C) are plots showing illustrative experimental accumulative optical flow track within 2 m spatial resolution for the experimental setup according to aspects of the present invention.

We validate the optical flow processing with a typical CP-COTDR experimental setup illustrated in FIG. 12(A). A DFB laser (100 kHz linewidth) was used as the light source. The pulse width was set to 100 ns, chirp bandwidth is 300 MHz. The sampling rate of the oscilloscope was 1.25 GSa/s. The trigger hold-off time is 10 ms, meaning that one hundred frames are captured per second. The function generator offered a ramp signal of 1.2Vpp and 1% symmetry. The fiber under test (FUT) is consisted of a 20-km SMF spool, followed by a 30-m fiber segment placed in a digital thermostatic water bath (Joanlab, BHS-1) and a 10-m PZT fiber stretcher (Optiphase, PZ1-SMF4-APC-E). A piece of reference fiber under vibration-isolated temperature stabilized box was used to calibrate the jitter noise in the CP-COTDR system due to the time misalignment of the pulsing and triggering.

Experiments were conducted under three test scenarios: (1) water heating, (2) water cooling, (3) dynamic strain. The CPCOTDR continuously captured the data for 60 seconds, acquiring six thousand frames as 2-D waterfall data. Optical flow processing is then implemented on the 20 km 2-D data to estimate the local shift. FIG. 12(B) and FIG. 12(C) shows the accumulative optical flow track within the 2-m spatial resolution. It is noted that the figures only display limited number of optical flow tracks for better illustration. Since the exact optical flow tracks are “pixel-wise” and the ensemble average length could be smaller than the optical pulse width, resulting in a higher spatial resolution (i.e., the density of accumulative optical flow tracks). The local shifts of the fiber segment in water bath were then converted to temperature change.

FIG. 12(D) and FIG. 12(E) are plots showing illustrative experimental water heating and cooling processes for the experimental setup according to aspects of the present invention. The measured water heating and cooling process are shown in FIG. 12(D) and FIG. 12(E). The temperature change rate in the water bath is fitted to be 0.028 degree/s for the heating process and −0.0011 degree/s for the cooling process. We also calibrated the temperature change rate using a high-accuracy thermometer, giving the average rate as 0.028 degree/s for heating process and −0.001 degree/s for the cooling process, which match perfectly with the CP-COTDR data. These results verify the effectiveness and accuracy of the proposed optical flow processing technique.

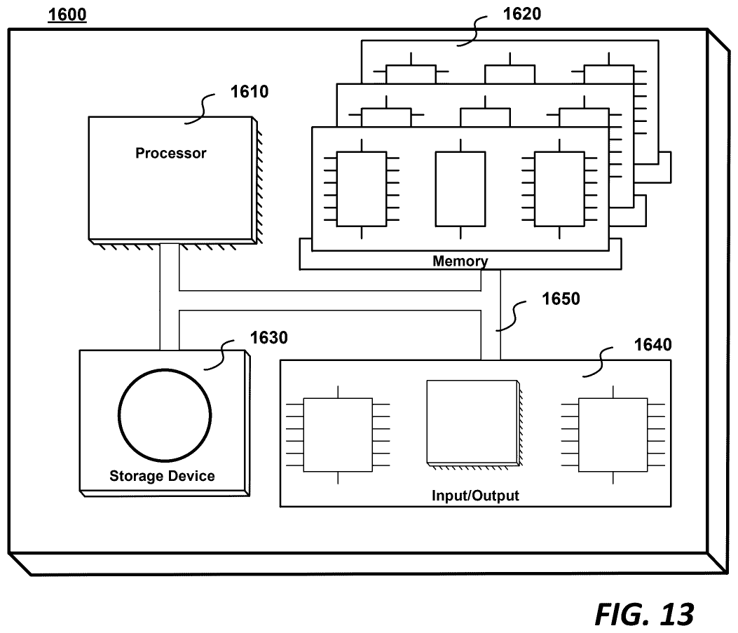

Finally, FIG. 13 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of several operating systems. The above-described methods of the present disclosure may be implemented on the computer system 1300 as stored program control instructions.

Computer system 1300 includes processor 1310, memory 1320, storage device 1330, and input/output structure 1340. One or more input/output devices may include a display. One or more busses 1350 typically interconnect the components, 1310, 1320, 1330, and 1340. Processor 1310 may be a single or multi core. Additionally, the system may include accelerators etc., further comprising a system on a chip.

Processor 1310 executes instructions in which embodiments of the present disclosure may comprise steps described in one or more of the Drawing figures. Such instructions may be stored in memory 1320 or storage device 1330. Data and/or information may be received and output using one or more input/output devices.

Memory 1320 may store data and may be a computer-readable medium, such as volatile or non-volatile memory. Storage device 1330 may provide storage for system 1300 including for example, the previously described methods. In various aspects, storage device 1330 may be a flash memory device, a disk drive, an optical disk device, or a tape device employing magnetic, optical, or other recording technologies.

Input/output structures 1340 may provide input/output operations for system 1300.

At this point, those skilled in the art will understand that while we have presented our inventive concepts and description using specific examples, our invention is not so limited. Accordingly, the scope of our invention should be considered in view of the following claims.

1. A computer-implemented method for distributed sensing using Chirp-Pulse Coherent Optical Time-Domain Reflectometry (CP-COTDR), the method comprising:
collecting a plurality of frames of raw data from a sensing fiber, wherein each frame comprises a plurality of spatial data points;
constructing a two-dimensional (2-D) data array from the plurality of frame, wherein the 2-D data array comprises a spatial dimension (x) and a temporal dimension (t);
calculating a spatial partial derivative (Iₓ) and a temporal partial derivative (Iₜ) for pixels within the 2-D data array;
estimating an optical flow (u) for pixels in the 2-D data array based on the spatial partial derivative and the temporal partial derivative; and
determining a local shift at a specific location on the sensing fiber based on the estimated optical flow to quantify an external physical perturbation.

2. The method of claim 1, wherein estimating the optical flow comprises solving an optical flow constraint equation defined as uₓ·Iₓ+Iₜ=0, where uₓ is an x-direction (horizontal) motion vector, Iₓ is a partial spatial gradient along x-direction, and Iₜ is a temporal gradient, wherein partial derivatives Iₓ and Iₜ can be approximated using the second-order central differences along x- and y-directions which can be expressed as:
$${I}_{x} ( k , l ) = \frac{I ( k , l + {h}_{x} ) - I ( k , l - {h}_{x} )}{2 {h}_{x}} + 𝒪 ( {h}_{x}^{2} )$$
$${I}_{t} ( k , l ) = \frac{I ( k + {h}_{t} , l ) - I ( k - {h}_{t} , l )}{2 {h}_{t}} + 𝒪 ( {h}_{t}^{2} )$$
where k=1, . . . , K, l=1, . . . , L. It is noted that the second-order central difference assumes the image has at least three continuous derivatives.

3. The method of claim 2, wherein estimating the optical flow utilizes a weighted least squares (WLS) calculation represented by:
$${\hat{u}}_{x} = {( {A}^{T} Q A )}^{- 1} {A}^{T} Q b .$$
where Q is the weighting matrix applied to each pixel within an analysis window and x-direction move ûₓ denotes a local shift of fiber location which corresponds to external temperature or strain variation.

4. The method of claim 3, wherein the weighting matrix Q is configured to minimize errors associated with areas of the 2-D data array having low variance in the spatial partial derivative.

5. The method of claim 1, further comprising: fitting an intrinsic gain ripple parameter, assumed to be identical for all EDFAs, using the line telemetry data acquired while the EDFAs are configured in the transparency mode.

6. The method of claim 5, further comprising: defining an analysis window (W) around a central pixel for estimating the optical flow, wherein a size of the analysis window is adaptively adjusted based on a local variation metric of the partial derivatives.

7. The method of claim 1, wherein the spatial partial derivative and the temporal partial derivative are approximated using second-order central differences.

8. The method of claim 1, wherein determining the local shift comprises: calculating an ensemble average of the estimated optical flows within a desired spatial resolution along the spatial dimension; and calculating a cumulative summation of the ensemble average along the temporal dimension.

9. The method of claim 1, further comprising converting the local shift into a temperature change value or a strain change value.

10. The method of claim 1, wherein the 2-D data array is normalized prior to calculating the partial derivatives.

11. An apparatus for distributed optical fiber sensing, comprising:
a laser source configured to generate chirp-modulated optical pulses;
an optical sensing fiber configured to receive the optical pulses and backscatter Rayleigh signals;
a detector configured to detect the backscattered Rayleigh signals;
and a processor configured to:
aggregate the detected signals into a two-dimensional (2-D) image array I(k,l) comprising spatial indices k and temporal indices I;
compute a spatial gradient matrix and a temporal gradient matrix from the 2-D image array;
calculate a motion vector for each pixel in the 2-D image array using a weighted least squares optical flow estimation; and
output a distributed sensing measurement based on the calculated motion vectors.

12. The apparatus of claim 11, wherein the processor is further configured to determine a flatness metric for the gradient matrices and dynamically adjust an analysis window size for the weighted least squares estimation based on a flatness metric.

13. The apparatus of claim 11, wherein the distributed sensing measurement comprises a distributed temperature profile or a distributed strain profile of the optical sensing fiber.

14. The apparatus of claim 11, wherein the processor computes the spatial gradient matrix and the temporal gradient matrix using a finite difference method applied to the 2-D image array.
